(19) United States
(12) Patent Application Publication
(10) Pub. No.: US 2014/0207668 A1
(43) Pub. Date: Jul. 24, 2014

(54) Temporary Virtual Payment Systems and Methods

(71) Applicant: MONEYGRAM INTERNATIONAL, INC., Minneapolis, MN (US)

(72) Inventors: Michael E. Hermansen, Shorewood, MN (US); Dianhai Du, Excelsior, MN (US); Jonathan Ryan Zoss, Brooklyn Park, MN (US)

(21) Appl. No.: 13/747,298

(22) Filed: Jan. 22, 2013

(51) Int. Cl. G06Q 20/10

(52) U.S. Cl. CPC G06Q 20/105
USPC 705/41; 705/39; 705/44

(57) ABSTRACT

Systems and methods which allow funds from one or more money transfer transactions to be delivered to a receiving party in a virtual form are provided. In some embodiments, a receiving party may receive a virtual credit card account for the money transfer amount, which can then be used to provide payment to an entity that accepts credit card transactions. In other embodiments, funds may be sent to a virtual account, such as a virtual wallet, which may be utilized to provide payments to third parties. In the event that a portion or all of the transferred funds are not utilized, embodiments may also provide for refunding the funds to the sending party.

### TECHNICAL FIELD

The present application relates to money transfer transactions, and more specifically to systems and methods for providing a recipient of a money transfer with virtual funds.

### BACKGROUND

Generally speaking, money transfer transactions are completed in a well-known sequence. The transaction begins when a sender initiates the transaction at the point in time when the money is to be sent to a receiving party. For example, a money transfer may be utilized in an emergency setting such as when a receiving party has an immediate need for funds. In such a transaction, a sender initiates a money transfer transaction by entering a money transfer agent location and provides the funds for the transaction to the money transfer agent. The agent may then provide a transaction code or some other form of transaction identifier to the sender. The sender will then provide the transaction code or identifier to the receiver. With this code, the receiving party enters an agent location and completes the transaction in order to receive the transferred funds.

Many times, the ability to send money via a money transfer is limited by the access of a sender and/or receiver to an agent location. For example, a receiving party in an emergency situation may be stranded in an rural area having limited access to agent options or locations. In this instance, the sending party may be restricted to using a specific agent or service provider in order to insure that the receiving party can receive the transferred funds. Further, the receiving party may be in an area which has no money transfer agents. Such a situation severely limits both a sending and receiving party's ability to address the present emergency.

### BRIEF SUMMARY

The present application provides for systems and methods which allow funds from one or more money transfer transactions to be delivered to a receiving party in a virtual form. In some embodiments, a receiving party may receive a virtual credit card account for the money transfer amount, which can then be used to provide payment to an entity that accepts credit card transactions. In other embodiments, funds may be sent to a virtual account, such as a virtual wallet, which may be utilized to provide payments to third parties. In the event that a portion or all of the transferred funds are not utilized, embodiments may also provide for refunding the funds to the sending party.

In accordance with one embodiment, a method for facilitating a money transfer is provided. The method includes receiving transaction information from a sending party at a processing device of a money transfer service. Upon receiving the transaction information, a virtual payment account is established which includes money transfer funds provided by the sending party. Further, the method includes providing a receiving party with access to the virtual payment account whereby the receiving party may utilize money transfer funds in the virtual payment account.

Another embodiment may be a system having at least one central processing unit belonging to a money transfer service entity. The system may be configured to receive money transfer transaction information from a sending party. The at least one central processing unit may be further configured to cause a virtual payment account to be established which includes money transfer funds provided by the sending party, wherein the virtual payment account is configured to be utilized by a receiving party of the money transfer transaction to make payments or purchases.

In yet another aspect, a method for facilitating a money transfer is provided. In this example, the method includes receiving money transfer transaction information from a sending party at a processing device of a money transfer service. A virtual payment account is established which includes money transfer funds provided by the sending party where the virtual payment account is configured to be accessible to a receiving party based on conditions provided by the sending party. Further, the method may include establishing a refund criteria which may provide for circumstances where some or all of the funds of the money transfer transaction may be refunded to the sending party.

The foregoing has outlined rather broadly the features and technical advantages of the present invention in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of embodiments described herein, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present embodiments.

### BRIEF DESCRIPTION OF THE DRAWINGS

For a more complete understanding, reference is now made to the following descriptions taken in conjunction with the accompanying drawings, in which:

FIG. 1 illustrates a system for facilitating one or more money transfer transactions in accordance with an embodiment of the present application;

FIG. 2 illustrates a flowchart of a method for facilitating a money transfer transaction in accordance with an embodiment of the present application; and

FIG. 3 illustrates a flowchart of a method for facilitating a money transfer transaction in accordance with an embodiment of the present application.

### DETAILED DESCRIPTION

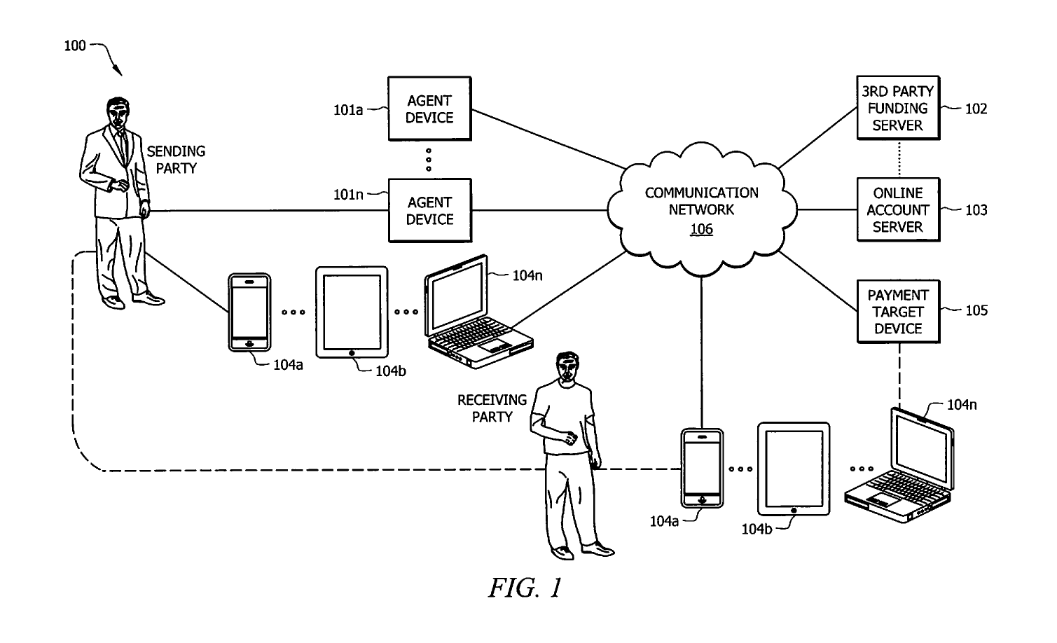

FIG. 1 illustrates a system 100 for facilitating one or more money transfer transactions in accordance with an embodiment of the present application. System 100 includes agent devices 101a-101n, third party funding server 102, online account server 103, user devices 104a-104n, and payment target device 105, each in communication with others over communication network 106.

Communications between devices in system 100 may be facilitated in whole, or in part, by communication network 106. Communication network 106 may comprise the Internet, WiFi, mobile communications networks such as GSM, CDMA, 3G/4G, WiMax, LTE, and the like. Further, communications network 106 may comprise a combination of network types working collectively.

Agent devices 101a-101n may correspond to computer systems within a money transfer agent location. Agent devices 101a-101n could include special purpose computers programmed to implement steps described herein, or could be conventional processing devices configured to run software which facilitates the described money transfer transactions. For example, such devices may be computer systems which are accessible by an agent at an agent location, may be automated machines such as an Automated Teller Machine (ATM), and the like. Agent devices 101a-101n may be located throughout the world and one or more devices may be utilized within a single money transfer transaction. Agent devices 101a-101n are configured to send and receive information over communication network 106. In some embodiments, agent devices 101a-101n may also have a direct connection with one or more devices of system 100 such as third party funding server 102, or online account server 103. Agent devices 101a-101n may be configured to transmit transaction information between respective devices of system 100.

Third party funding server 102 may be implemented as a computing device, as a network of computing devices, or in any manner that facilitates one or more of the storage, compilation and communication of transaction information within system 100. Third party funding server 102 may be administered by a third party financial services entity such as a bank, credit card company, online payment service (e.g. PayPal), an online wallet provider (e.g. Google Wallet), etc., or a combination of entities working cooperatively to implement the methods described herein. Third party funding server 102 may be configured to receive information relating to a money transfer transaction and facilitate the creation of a virtual funding account for the receiving party.

For example, in one embodiment, third party funding server 102 may be administered by a credit card company and upon receiving transaction information from a money transfer service, third party funding server may facilitate the creation of a credit card account number which may be utilized by a receiving party to pay for a purchase using transferred funds. Such a credit card account number may include any information which could be needed to perform a transaction (e.g. credit card number, expiration date, security personal identification number, etc.). The credit card account may be administered within third party funding server 102 or may be established and administered in a separate server such as online account server 103.

Third party funding server 102 may further comprise an online wallet service which maintains an account that is accessible to a receiving party for the purposes of providing payment for a transaction taken by the receiving party. Such an account may also be administered within third party funding server 102 or may be established and administered in a separate server such as online account server 103.

As discussed above, online account server 103 may administer one or more accounts created by third party funding server 102. Control of administration of the online account server may remain with a third party or a money transfer service agent. For example, in an embodiment where a virtual credit card account is created, once the account is created, the money transfer service may administer the finances in the account so as to provide payments for the receiving party, refunds to the sending party, and the like. In such examples, the money transfer service may maintain control of authorizing payments, cooperate with the credit card company for such authorizations, or a maintain joint efforts.

It is appreciated that in some embodiments a money transfer may be made on a condition that the receiving party utilize the funds for a specific purpose, e.g. to pay for an emergency service/good, provide for specific payment of bills, etc. These restrictions may be administered within one or more of third party funding server 102 or online account server 103. Additionally, these conditions may be monitored and/or payment may be authorized by one or more of a third party or the money transfer service.

In some embodiments a money transfer transaction may comprise the money transfer service establishing and administering the virtual account without the assistance of a third party. For example, the agent device 101 may transmit transaction information to online account server 103 whereupon the funds are provided to an existing virtual account and/or an account is established. Such a virtual account may be a virtual wallet that is able to provide payment of funds using various transfer means known in the art, e.g. utilizing smart phone electronic transfers, and the like.

User devices 104a-104n may be any type of device which would facilitate the exchange of information within system 100. For example, client devices may include computer systems, tablet devices, mobile telephones, and the like. Different embodiments may utilize different aspects of the types of client devices. For example, mobile telephones and tablet devices may have the ability to connect with various communications networks and may have different application execution capabilities. User devices 104a-104n may be utilized before, during and after a money transfer transaction in any manner to facilitate convenient and secure transactions.

For example, user device 104 may be utilized to initiate a transaction. One aspect may include a dedicated app or online interface corresponding to a money transfer service which can compile information relating to the send portion of the money transfer transaction and may in some instances accept funds for the transaction. Such embodiments may fully establish the money transfer transaction and cause other portions of system 100 to create virtual payment accounts, etc. In another embodiment, user device 104 may compile data corresponding to the send portion of the transaction and provide this information to an agent device 101 whereupon the sending party may utilize agent device 101 to finalize the transaction.

Device 104 may also be configured in a manner to receive statements, either periodically or in real time, which notify the sending party of any action taken with respect to the virtual payment account. Such a statement may be received over an interne connection, as part of a mobile app, and the like. In further embodiments, device 104 may be utilized to prevent one or more payments from a virtual payment account. Such an action may be implemented in real time with a purchase or may be set to work moving forward. It is further noted that any functionality that a sending party may implement on device 104 may be configured to be implemented within a money transfer agent setting, such as on agent device 101.

Embodiments may utilize one or more user devices 104 on the receive portion of the transaction. For example, a receiving party may receive virtual payment information at user device 104, such as a virtual credit card account number, online account information, and the like, over communication network 106 (e.g. via a data connection, SMS, voice call, etc.) from one or more of the sending party, agent device 101, third party funding server 102 or online account server 103.

In some embodiments, user device 104 may include payment transmission capabilities which allow payment from an online or virtual account to be tendered to an target payee. For example, user device 104 may execute an app or provide for online access to an account and cause funds to be tendered from an online/virtual account to a target payee. In some embodiments, user device 104 may be in direct communication with a target payee and may transfer payment account information utilizing a scannable code (e.g. UPC code, QR code, and the like), infra-red communication, RF communication (e.g. blue-tooth transmissions and the like), near field communication technology, etc.

System 100 includes payment target device 105. Such a device may be any device within an establishment that accepts funds for goods and/or services (e.g. a retail establishment, a service provider, an online retailer, etc.). For example, in the event that a money transfer has been initiated to assist a receiving party with an emergency car repair, payment target device may include a device within a car repair establishment which is capable of accepting one or more virtual payment means. Such a device may be implemented as a credit card acceptance device whereupon a virtual credit card number is provided to the device and the device authorizes the transaction as though a normal credit card account is being utilized.

In another embodiment, payment target device may include a device which is capable of receiving authorization from an online account such as an online wallet, etc. Communication to receive such authorization may be implemented over communication network 106. Further, account information may be provided to payment target device in any manner such as directly from the receiving party, from a user device 104, from one or more funding or account servers, etc.

It is noted that while specific devices are outlined with respect to FIG. 1, embodiments may be implemented using many types of hardware and processing resources. Specifically, any number of devices which are functional to establish a money transfer transaction, accept funds, and create an account which may be accessible by a receiving party and utilized to provide payment for goods or services with the created account, may be utilized. Such systems would not generally require the receiving party to enter a money transfer service location to complete the receiving portion of the transaction, while still providing the receiving party with access to the transferred funds.

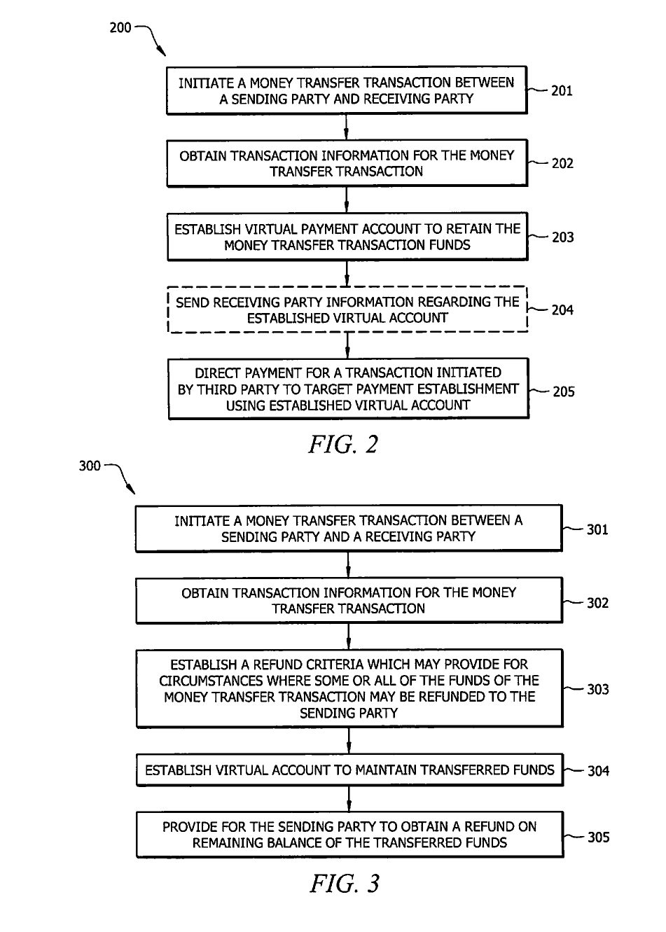

FIG. 2 illustrates a flowchart of a method 200 for facilitating a money transfer transaction in accordance with an embodiment of the present application. Method 200 may be implemented within a system such as system 100 or any other suitable system. Additionally, while method 200 is set forth in steps, it is noted that nothing in this application necessarily limits the order in which the illustrated steps are implemented. In fact, some steps may be implemented in different orders, simultaneously, at multiple points in time, or not at all.

Method 200 begins by initiating a money transfer transaction at block 201. Such a money transfer transaction may be initiated by a customer using a personal computing device, visiting a money transfer service location in person and using an on-site device or an agent, etc. The money transfer service obtains transaction information at block 202. Transaction information may originate from a user and include identifying information for the user, destination information for the money transfer transaction, and the like. Additionally, in some embodiments transaction information may be retrieved from a customer database which maintains information about a particular customer such as personal information and transaction history information. The customer database may be linked to a customer loyalty database which maintains such information and administers a loyalty program.

Method 200 may then establish a virtual payment account at block 203. As discussed above, a virtual payment account may comprise a credit card-style account with an account number with may be utilized in a credit card authorization network. Further, a virtual payment account may comprise an online account or a virtual wallet which may be utilized by a receiving party to utilize transferred funds for payment for different transactions. Such a virtual payment account may be established at the time the money transfer transaction is established and may be administered by a third party, a money transfer service, or a combination of both.

Method 200 may further include optional steps of receiving, by the receiving party, transaction information regarding the money transfer transaction at block 204. Such transaction information may include a notification that a money transfer has been sent to the receiving party, information regarding an established virtual account, and the like. With this information, the receiving party may direct payment for a transaction initiated by the third party to a target payment establishment using the established virtual account at block 205. For example, in the case of a virtual credit card, a receiving party may receive information regarding the virtual credit card number and then utilize that number to pay for a transaction at a target establishment such as an online retailer, or other provider of goods and/or services.

It is noted that in some embodiments, the ability of a receiving party to provide the transferred funds to a target establishment may be governed, in whole or in part, by the sending party. For example, the sending party may specify that transferred funds may be utilized for specific purposes, for specific amounts, for a specified period of time, etc. For example, a sending party may be providing the funds for a specific purpose, e.g. helping in an emergency, paying for a specific good/service for the receiving party, etc. In such an embodiment, the virtual payment account may include one or more restriction codes or other notifiers that a purchase may be authenticated against at the time when a receiving party is attempting to draw on the virtual payment account.

FIG. 3 illustrates a flowchart of a method 300 for facilitating a money transfer transaction in accordance with an embodiment of the present application. As was the case with respect to the flowchart of FIG. 2, method 300 may be implemented within a system such as system 100 or any other suitable system. Additionally, while method 300 is set forth in steps, it is noted that nothing in this application necessarily limits the order in which the illustrated steps are implemented. In fact, some steps may be implemented in different order, simultaneously, at multiple points in time, or not at all.

Method 300 begins by initiating a money transfer transaction at block 301. As with the method 200, such a money transfer transaction may be initiated by customer using a personal computing device, visiting a money transfer service location in person and using an on-site device or an agent, etc. The money transfer service obtains transaction information at block 302. Transaction information may originate from a user and include identifying information for the user, destination information for the money transfer transaction, and the like. Additionally, in some embodiments, transaction information may be retrieved from a customer database which maintains information about a particular customer such as personal information and transaction history information. The customer database may be linked to a customer loyalty database which maintains such information and administers a loyalty program.

Method 300 further includes establishing a refund criteria which may provide for circumstances where some or all of the funds of the money transfer transaction may be refunded to the sending party at block 303. Such a refund criteria may be set according to any number of considerations. For example, a sender may desire that funds for the money transfer be utilized for only a specific period of time, for purchasing a specific good or service, etc., whereupon after such a condition has been met, any remaining balance may be refunded to the sending party.

At block 304 a virtual account is established which maintains the transferred funds from the sender. This virtual account may be available to a receiving party for use based upon considerations set forward by the sending party. Upon the receiving party completing their authorized use of the transferred funds, method 300 includes providing for the sending party to obtain a refund on remaining balance of the transferred funds at block 305. Such a step may include one or more intermediate notification steps which notify the sending party that a specified criteria has been met (e.g. that the funds have paid for a specific good/service, a period of time has expired, etc.). Accordingly, some embodiments may allow for the sending party to maintain a degree of control over transferred funds and to even receive a refund on transferred funds which are not fully used. A refund may be automatically provided upon meeting a certain criteria or may require initiation of a process by a sending party. Refund processes may be implemented using any means, such as by using devices within system 100.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method for facilitating a money transfer, said method comprising:
receiving transaction information from a sending party at a processing device of a money transfer service;
establishing, by said processing device, a virtual payment account which includes money transfer funds provided by the sending party, said virtual payment account comprising a credit card account established after said receiving transaction information; and
providing a receiving party with access to the virtual payment account, said virtual payment account configured for the receiving party to utilize money transfer funds in the virtual payment account.

2. (canceled)

3. The method of claim 1 wherein establishing a virtual payment account comprises providing funds to an online wallet service account.

4. The method of claim 1 wherein the virtual account is configured to provide payment funds for a transaction conducted with an online retailer.

5. The method of claim 1 wherein the virtual account is configured to provide payment to a provider of goods or services which accepts the payment from the virtual account at a physical establishment.

6. The method of claim 1 wherein providing the receiving party with access to the virtual payment account comprises sending virtual account information to an electronic device of the receiver.

7. The method of claim 1 wherein the virtual account information is provided in a manner so that an electronic device utilizes the information to transmit payment information to a target payee using one or more of a scannable code displayed on the electronic device, near field communication transmissions, infra-red transmissions, and radio frequency transmissions.

8. The method of claim 1 further comprising establishing a refund procedure whereby funds from the virtual payment account are refunded to the sending party if a certain condition is met.

9. The method of claim 1 further comprising receiving conditions from the sending party which govern the use of the virtual payment account with respect to the sender and applying the received conditions as restrictions on the virtual account.

10. The method of claim 9 further comprising, upon receiving a request to withdraw funds from the virtual payment account, authenticating the transaction based on the received conditions.

11. A system comprising:
at least one central processing unit belonging to a money transfer service entity configured to receive money transfer transaction information from a sending party, said at least one central processing unit further configured to cause a virtual payment account comprising a credit card account to be established which includes money transfer funds provided by the sending party, wherein the virtual payment account is configured to be utilized by a receiving party of the money transfer transaction to make payments or purchases.

12. The system of claim 11 further comprising an online account server in communication with said at least one central processing unit which administers the virtual payment account.

13. The system of claim 11 wherein the central processing unit is configured to send information to or receive information from the sending party and receiving party.

14. The system of claim 11 wherein the central processing unit is configured to transmit information regarding the virtual payment account to the receiving party.

15. A method for facilitating a money transfer, said method comprising:
receiving money transfer transaction information from a sending party at a processing device of a money transfer service;
establishing, by said processing device, a virtual payment account which includes money transfer funds provided by the sending party, said virtual payment account comprising a credit card account established after said receiving money transfer transaction information, said virtual payment account configured to be accessible to a receiving party based on conditions provided by the sending party; and
establishing, by said processing device, a refund criterion for which some or all of the funds of the money transfer transaction are refunded to the sending party.

16. The method of claim 15 wherein the criteria circumstances comprises one or more of an expiration of a time period, a count of transaction withdrawals from the virtual payment account, and a pre-determined amount has been withdrawn from the virtual account while a balance remains.

17. The method of claim 15 further comprising notifying the sending party that a refund criterion has been met.

18. The method of claim 15 wherein the conditions for accessing the virtual payment account include a condition on the type of transaction being funded.

19. The method of claim 15 wherein the conditions for accessing the virtual payment account include a condition on the type product or service being purchased.

20. The method of claim 15 wherein the virtual payment account is implemented as one or more of an online payment account, a virtual credit card, and a virtual wallet.
